(19) United States
(12) Patent Application Publication
(10) Pub. No.: US 2026/0080344 A1
(43) Pub. Date: Mar. 19, 2026

(54) TAIWA KPI REMUNERATION SYSTEM

(71) Applicant: Oliver Phillips, Santa Barbara, CA (US)

(72) Inventor: Oliver Phillips, Santa Barbara, CA (US)

(73) Assignee: Empowerment Holdings LLC, Santa Barbara, CA (US)

(21) Appl. No.: 19/401,114

(22) Filed: Nov. 25, 2025

Related U.S. Application Data
(63) Continuation-in-part of application No. 19/189,096, filed on Apr. 24, 2025.
(60) Provisional application No. 63/640,203, filed on Apr. 30, 2024.

(51) Int. Cl. G06Q 10/0639

(52) U.S. Cl. CPC G06Q 10/06393; G06Q 10/06398

(57) ABSTRACT

The present invention provides a computer-implemented system and method for automated remuneration based on individual contributions to organizational key performance indicators (KPIs). The system includes a data collection module that aggregates KPI data from multiple sources; an attribution engine that evaluates individual impact using configurable attribution models; and a Negative Improvement (NI) Balancing mechanism that adjusts attribution scores by accounting for trade-offs, degradations, and zero-sum effects across KPIs. A reward calculation module converts net attribution scores into financial rewards while enforcing budget constraints, and a smart-contract distribution layer executes reward payments through a two-gate validation process ensuring data integrity, policy compliance, and auditability. The system further includes baseline-to-delta tracking, privacy safeguards, cross-organizational data-exchange capabilities, economic modeling, user dashboards, and integrated audit trails. These elements collectively create a transparent, data-driven remuneration infrastructure that aligns individual actions with organizational outcomes and ensures fair, real-time compensation for measurable contributions.

### CROSS-REFERENCE TO RELATED APPLICATIONS

This application is a Continuation-in-Part of U.S. patent application Ser. No. 19/189,096, filed Apr. 24, 2025, which claims the benefit of U.S. Provisional Patent Application No. 63/640,203, filed Apr. 30, 2024. The contents of both applications are incorporated herein by reference in their entirety.

### FIELD OF THE INVENTION

This invention relates to systems and methods for employee remuneration based on key performance indicators (KPIs), and more particularly to automated systems that attribute rewards to specific individuals based on their measurable contributions to organizational KPIs.

### BACKGROUND

Traditional employee compensation systems typically rely on fixed salaries, subjective performance reviews, and discretionary bonuses that are determined by management judgment. While these approaches have served organizations for decades, they suffer from several significant limitations:

First, the connection between individual employee actions and organizational outcomes is often unclear. When a company achieves improved customer satisfaction scores, for example, it can be difficult to determine which employees'efforts contributed most significantly to that improvement. This lack of attribution can lead to perceived unfairness in reward distribution and can fail to properly incentivize the behaviors that actually drive organizational success.

Second, traditional systems often fail to account for the interconnected nature of modern work. An organization's success typically depends on the coordinated efforts of multiple departments and individuals, yet compensation systems tend to operate in silos. A customer service representative might significantly improve customer retention, but if their contribution isn't properly measured and attributed, they may not receive appropriate recognition or compensation.

Third, existing systems rarely provide real-time feedback to employees about how their work is affecting organizational metrics. Employees often must wait for quarterly or annual reviews to understand whether their efforts are having the desired impact, which reduces the motivational effectiveness of performance-based compensation.

There is therefore a need for an automated, data-driven remuneration system that can accurately attribute organizational KPI improvements to specific individuals, provide real-time feedback, and distribute rewards in a transparent and equitable manner.

### PRIOR ART DISTINCTION

While previous implementations of performance-based incentive systems have relied on additive reward structures, static KPI targets, single-actor attribution, or simple token-based reward mechanisms, such systems typically fail to account for multi-actor contributions, cross-KPI trade-offs, or real-time, automated remuneration tied to measurable behavioral deltas. They also lack mechanisms for detecting zero-sum scenarios, adjusting improvements that cause degradations elsewhere, or reconciling reward allocations across organizational boundaries.

Systems and methods provided herein, by contrast, introduce a multi-model attribution engine, Negative Improvement (NI) Balancing, baseline-to-delta tracking, and a smart-contract-enabled settlement architecture that enforces auditability, budget constraints, and cross-organizational fairness. These features constitute a significant distinction and improvement over existing incentive, attribution, or token-based systems without requiring citation of specific prior art.

### SUMMARY OF THE INVENTION

The present invention addresses these needs by providing an automated KPI-based remuneration system that tracks organizational performance metrics, attributes improvements to specific individuals through sophisticated analysis, and distributes financial rewards accordingly.

In one aspect, the invention provides a computer-implemented system for employee remuneration comprising: a data collection module that gathers organizational KPI data from multiple sources; an attribution engine that analyzes the collected data to determine which individuals'actions contributed to KPI improvements; a reward calculation module that determines appropriate financial rewards based on the attributed contributions; and a distribution system that delivers the calculated rewards to employees.

A key innovation of the present invention is its use of ‘Negative Improvement (NI) Balancing’—a mechanism that accounts for situations where an individual's improvement in one area might come at the expense of decline in another area, or where one person's improvement might negatively impact others. This ensures that rewards are distributed fairly even in zero-sum or partially zero-sum scenarios.

The system further includes privacy-preserving techniques to protect sensitive employee data, smart contract logic to ensure transparent and tamper-proof reward distribution, and cross-organizational data exchange capabilities that allow the system to operate across multiple entities or business units.

### BRIEF DESCRIPTION OF THE DRAWINGS

FIG. 1 is a block diagram of a KPI-based remuneration system 100 according to an embodiment of the invention. The diagram illustrates KPI data sources 112, a data collection and integration module 120, a centralized data warehouse 122, an attribution and analysis engine 130 including a Negative Improvement (NI) Balancing module 132, a reward calculation module 140, a baseline-to-delta tracking module 160, a distribution and smart contract layer 150, a blockchain or distributed ledger 152, privacy and fraud prevention safeguards 170, a cross-organizational data exchange module 180, an economic modeling and budget allocation module 190, user interface components 200, scalability and performance optimization components 210, audit and compliance components 220, and extension and modularity components 230.

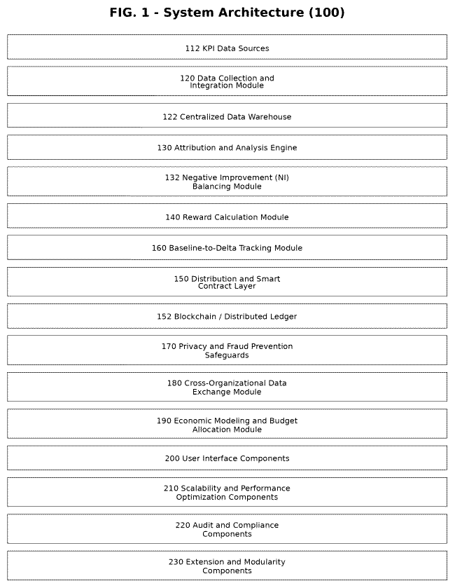

FIG. 2 is a data flow diagram illustrating an example flow of KPI data within system 100. KPI data sources 112 provide data to data collection and integration module 120, which stores normalized data in data warehouse 122. The attribution and analysis engine 130 retrieves data from warehouse 122, applies attribution models, and passes results to the NI Balancing module 132. The adjusted attribution results are then provided to reward calculation module 140 and economic modeling and budget allocation module 190. The distribution and smart contract layer 150, in conjunction with blockchain or distributed ledger 152, executes validated reward payments and exposes aggregated results to user interfaces 200.

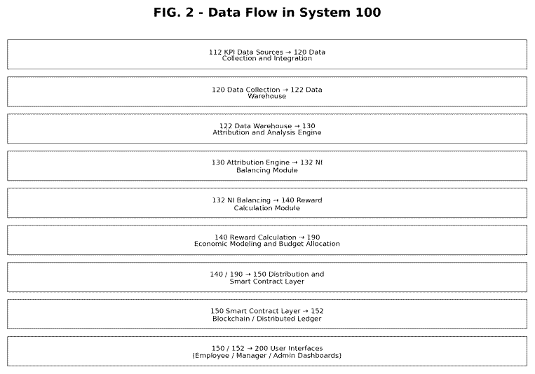

FIG. 3 is a schematic diagram of a two-gate validation process executed by smart contract logic within distribution layer 150. Reward calculation outputs from module 140 are first subjected to Gate 1 automated validation 154, which verifies data integrity, calculation accuracy, policy compliance, and anomaly detection. If Gate 1 passes, Gate 2 management review 156 optionally allows authorized personnel to approve, adjust, or reject proposed rewards, after which transactions are recorded on blockchain or distributed ledger 152 and payouts are triggered.

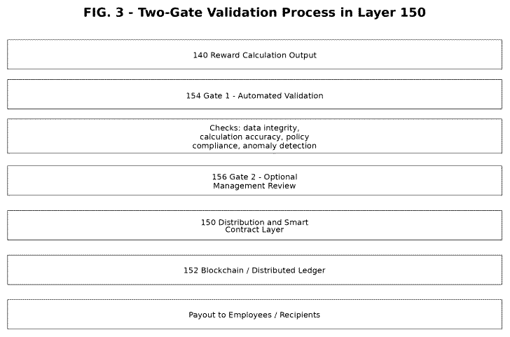

FIG. 4 is a timeline diagram illustrating baseline-to-delta tracking performed by module 160. A baseline period from time t0 to time t1 is used to compute an initial Baseline_Value for a given KPI. From time t1 to t2, the system measures Current_Performance and computes a Delta as the difference between Current_Performance and Baseline_Value. At time t2, the system optionally updates the baseline using an exponential weighted moving average to produce a New_Baseline. Subsequent periods repeat this process, allowing system 100 to distinguish transient fluctuations from sustained improvements.

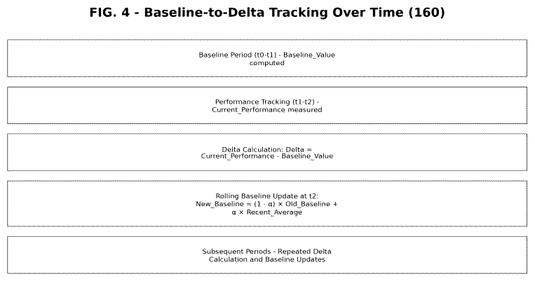

FIG. 5 is a flowchart illustrating a computer-implemented method 500 for employee remuneration according to an embodiment of the invention. The process includes data collection 510 from multiple KPI data sources, attribution model application 520, NI Balancing adjustment 530, reward calculation with budget constraints 540, a two-gate validation process 550, and distribution of rewards via smart contracts 560, with a feedback loop allowing recalculation if validation fails.

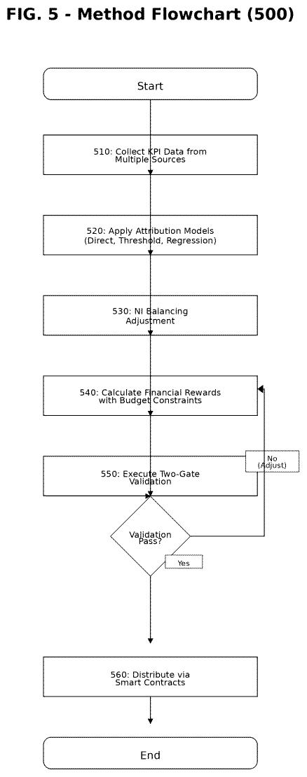

FIG. 6 is a diagram illustrating detailed operation of the Negative Improvement (NI) Balancing module 132. The figure shows a KPI impact matrix 132a defining positive and negative relationships between KPIs, employee-specific KPI delta values 132b, and an NI Balancing computation 132c that applies weighted penalties for negative cross-KPI impacts to produce a net improvement score.

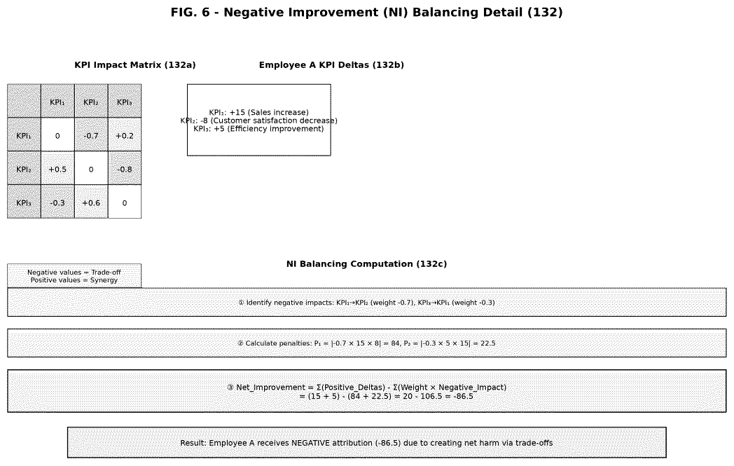

FIG. 7 is an architecture diagram illustrating a cross-organizational federated data exchange module 180 according to an embodiment of the invention. The figure shows multiple organization instances 180a, 180b, 180c, each with a local system 100, local database 182, and API gateway 184, all connected through a secure API exchange layer 186 governed by shared configuration data 188 defining shared KPIs, data granularity, synchronization frequency, and access controls.

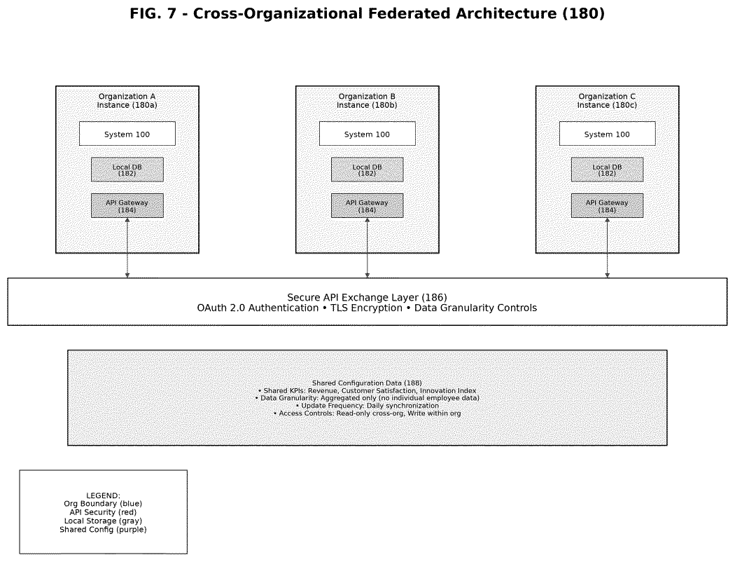

### DETAILED DESCRIPTION

### System Architecture Overview

The TAIWA KPI Remuneration System comprises several interconnected modules that work together to collect data, analyze performance, attribute improvements, calculate rewards, and distribute compensation. The system architecture is designed to be modular, scalable, and extensible to accommodate various organizational structures and requirements.

At the highest level, the system includes: (1) Data Collection and Integration Layer, (2) Attribution and Analysis Engine, (3) Reward Calculation Module, (4) Distribution and Smart Contract Layer, (5) User Interface and Feedback Systems, and (6) Compliance and Audit Trail Components.

### Data Collection and Integration

The Data Collection module serves as the foundation of the system, gathering relevant KPI data from multiple sources across the organization. These sources may include customer relationship management (CRM) systems, financial reporting tools, human resources information systems (HRIS), project management platforms, customer feedback channels, and any other systems that track metrics relevant to organizational performance.

The module employs various integration techniques including API connections, database queries, file imports, and real-time data streams. Each data source is configured with appropriate authentication, access controls, and data validation rules to ensure security and integrity.

The collected data is normalized and stored in a centralized data warehouse optimized for analytical queries. The system maintains historical data to enable trend analysis and baseline establishment for measuring improvements over time.

### Attribution Models

The Attribution Engine is the core analytical component of the system, responsible for determining which individuals'actions contributed to observed KPI improvements. The system employs multiple attribution models, each suitable for different types of KPIs and organizational contexts.

Direct Correlation Model: This model is used when there is a clear, measurable relationship between an individual's actions and a KPI outcome. For example, if a sales representative closes a deal, their contribution to revenue KPIs can be directly attributed. The mathematical formulation for direct attribution is: Attribution_Score=(Individual_Impact/Total_Impact)×KPI_Improvement_Value, where Individual_Impact represents the measurable contribution of the specific person and Total_Impact represents the sum of all measured contributions.

Threshold-Based Model: This model applies when improvements occur in discrete steps rather than continuously. For instance, customer satisfaction might need to reach certain thresholds before triggering rewards. The system defines threshold values (T1, T2,. . . Tn) and attribution occurs only when KPI values cross these thresholds. Attribution follows the formula: if KPI_Current>Threshold_i and KPI_Previous<=Threshold_i, then Attribution_Triggered=TRUE for contributors active during the improvement period.

Regression-Based Model: For complex scenarios where multiple factors influence a KPI, the system employs regression analysis to estimate each individual's contribution. The model uses the form: KPI_Change=β₀+β₁ (Individual₁_Actions)+β₂ (Individual₂_Actions)+ . . . +βn(Individualn_Actions)+ϵ, where β coefficients represent the estimated impact of each individual's actions on the KPI, calculated through statistical analysis of historical data.

The system allows administrators to configure which attribution model applies to each KPI, and can even employ hybrid approaches where multiple models are combined with weighted averages to provide more accurate attribution in complex scenarios.

### Negative Improvement (NI) Balancing

A critical innovation in the present invention is the NI Balancing mechanism, which addresses situations where improvements are not purely additive. There are several scenarios where NI Balancing is essential:

First, zero-sum situations where one person's gain directly causes another's loss. For example, if a sales representative takes over accounts from another representative and improves their metrics, the system must recognize that the overall organizational improvement is less than it would appear from looking at the improving representative in isolation.

Second, trade-off scenarios where improving one metric degrades another. An employee might increase sales volume but at the cost of lower profit margins, or might improve processing speed but reduce quality. The NI Balancing mechanism evaluates the net organizational benefit.

The mathematical implementation of NI Balancing calculates a Net Improvement Score: Net_Improvement=Positive_Improvements−(Weight_Factor×Negative_Improvements), where the Weight_Factor is configurable based on organizational priorities and the relative importance of different KPIs.

The system tracks both improvements and degradations across all relevant KPIs for each individual, and applies the NI Balancing formula before calculating final reward amounts. This ensures that rewards reflect true net value creation rather than narrow metrics that might be gameable or misleading.

### Smart Contract Logic

The reward distribution system employs smart contract technology to ensure transparency, immutability, and automated execution of reward payments. Smart contracts are self-executing programs stored on a blockchain or similar distributed ledger that automatically trigger predetermined actions when specified conditions are met.

In the present invention, smart contracts encode the reward distribution rules, including: (1) Attribution thresholds that must be met before rewards are distributed, (2) Calculation formulas for converting attribution scores to monetary amounts, (3) Distribution timing and frequency, (4) Validation rules to prevent fraud or errors, and (5) Audit trail requirements for compliance.

The system implements a two-gate validation logic where rewards must pass through both automated validation (Gate 1) and optional management review (Gate 2) before distribution. Gate 1 automatically verifies: data integrity (ensuring all input data is valid and complete), calculation accuracy (verifying that attribution and reward calculations are mathematically correct), policy compliance (confirming that reward amounts comply with organizational policies and budget constraints), and fraud detection (checking for suspicious patterns or anomalies).

Gate 2 is optional and can be configured by administrators. When enabled, calculated rewards are held pending management review for approval. This hybrid approach balances automation benefits with organizational oversight requirements. Once both gates are passed, the smart contract automatically initiates payment through integrated payroll systems.

### Baseline-to-Delta Tracking

To accurately measure individual improvement, the system must establish performance baselines and track changes (deltas) over time. The Baseline-to-Delta Tracking module implements this functionality through several components.

First, baseline establishment: When an employee begins being tracked by the system, or when a new KPI is added, the system collects initial performance data over a defined baseline period (typically 30-90 days). This baseline represents the employee's typical performance level before any improvement initiatives or rewards are offered. The baseline calculation uses statistical methods to account for normal variation: Baseline_Value=median(Performance_Data[baseline_period]) to provide a robust measure resistant to outliers.

Second, delta calculation: After the baseline period, the system continuously measures actual performance against the baseline to calculate improvement deltas: Delta=Current_Performance−Baseline_Value. Positive deltas represent improvements and negative deltas represent degradations.

Third, rolling baseline updates: To account for sustainable improvements that become the new normal, the system periodically updates baselines. The update frequency is configurable (typically quarterly or annually) and uses an exponential weighted moving average to gradually incorporate sustained improvements: New_Baseline=(1−α)×Old_Baseline+α×Recent_Average_Performance, where α is a smoothing parameter between 0 and 1.

This approach ensures that employees are rewarded for genuine improvements rather than temporary fluctuations, while also preventing permanent inflation of baselines that would make future improvements unrewarded.

### Privacy and Fraud Prevention Safeguards

Given that the system processes sensitive employee performance and compensation data, robust privacy and security measures are essential. The system implements multiple layers of protection.

Data Encryption: All data is encrypted both in transit (using TLS 1.3 or higher) and at rest (using AES-256 encryption). Encryption keys are managed through a dedicated key management service with regular rotation schedules.

Access Controls: The system implements role-based access control (RBAC) with the principle of least privilege. Employees can view only their own performance data and rewards. Managers can view data for their direct reports. System administrators have broader access but all access is logged. Sensitive operations require multi-factor authentication.

Anonymization for Analysis: When conducting system-wide analysis or generating reports, the system can anonymize individual identifiers. This allows statistical analysis and system optimization without exposing individual performance details.

Fraud Detection: The system employs multiple fraud detection mechanisms including: anomaly detection algorithms that flag unusual patterns in performance data or reward calculations; duplicate transaction prevention to ensure rewards aren't paid multiple times; cross-validation of data sources to identify discrepancies that might indicate data manipulation; and time-based validation to detect suspicious timing patterns in data submission or approval.

Audit Trails: Every system action is logged with timestamps, user identifiers, and affected data elements. These logs are immutable and retained for compliance purposes. Any modification to reward calculations, attribution rules, or KPI configurations is recorded with before/after values and approval chains.

### Cross-Organization Data Exchange

Modern organizations often operate across multiple entities, subsidiaries, or business units. The system includes capabilities for cross-organizational data exchange to enable consolidated KPI tracking and reward distribution across organizational boundaries.

The cross-organizational module implements a federated architecture where each organization maintains its own instance of the system with local data storage and processing, but instances can securely exchange data through standardized APIs. The API specifications include: authentication using OAuth 2.0 or similar protocols; data format standards using JSON or XML schemas; encryption requirements for data in transit; rate limiting and throttling to prevent system abuse; and versioning to maintain compatibility as the system evolves.

Data exchange occurs through several mechanisms: Push notifications where one organization sends KPI updates to other organizations when significant changes occur; Pull requests where an organization queries another for specific KPI data on demand; Batch synchronization where data is exchanged on a scheduled basis (e.g., daily or weekly); and Event-driven updates where specific events trigger immediate data exchange.

The system includes configuration tools that allow administrators to specify: which KPIs should be shared across organizations; which organizations have access to specific data; what level of data granularity is shared (aggregated vs. individual-level); and how frequently data should be synchronized. This flexibility allows organizations to balance the benefits of cross-organizational visibility with privacy and competitive confidentiality requirements.

### Economic Modeling and Budget Allocation

A critical practical aspect of any remuneration system is ensuring that reward distributions align with organizational budget constraints and economic realities. The system includes sophisticated economic modeling capabilities to optimize reward allocation.

Budget management operates at multiple levels: Global budget caps that limit total rewards across the organization; Department or unit-level budgets that allocate resources to specific business areas; Individual employee reward caps that prevent disproportionate concentration of rewards; and Time-based budget periods (monthly, quarterly, annually) with carryover rules for unused funds.

The system implements a reward calculation algorithm that incorporates budget constraints: For each reward period, calculate total earned rewards across all employees based on attribution scores; Compare total earned rewards to available budget; If earned rewards exceed budget, apply a scaling factor: Actual_Reward=Earned_Reward×(Available_Budget/Total_Earned_Rewards); Distribute scaled rewards to employees; If earned rewards are below budget, options include: distributing full earned rewards and reserving remainder, applying a bonus multiplier to all rewards, or carrying unused budget to the next period.

The economic modeling module also calculates return on investment (ROI) metrics to help organizations assess the effectiveness of the remuneration system: ROI=(KPI_Improvements_Value−Total_Rewards_Cost)/Total_Rewards_Cost. The system tracks ROI over time and can generate reports showing which KPIs, departments, or initiatives generate the best returns.

Advanced features include scenario modeling where administrators can simulate different reward structures and budget allocations to predict outcomes before implementation, and optimization algorithms that suggest optimal budget allocation across different KPIs or business units to maximize organizational benefit.

### User Interface and Feedback Mechanisms

To maximize the motivational impact of the remuneration system, employees need visibility into how their actions affect KPIs and what rewards they are earning. The system provides comprehensive user interface components for different stakeholder types.

Employee Dashboard: Individual contributors access a personalized dashboard showing: Their current performance on tracked KPIs with visual representations (graphs, charts); How their performance compares to their baseline and to organizational averages (anonymized); Attribution scores showing how their work has contributed to organizational outcomes; Earned rewards (pending and paid) with breakdown by KPI; Actionable insights suggesting which areas of improvement would generate greatest reward potential; Historical trends showing performance over time.

Manager Dashboard: People managers see: Aggregated team performance across all tracked KPIs; Individual performance for direct reports; Budget utilization and remaining reward allocation capacity; Pending approvals if Gate 2 review is enabled; Team trends and comparative analysis; Tools for providing feedback and recognition beyond automated rewards.

Administrator Console: System administrators access: Configuration tools for KPIs, attribution models, reward calculations, and budgets; System health monitoring and performance metrics; Audit logs and compliance reports; Data integration status and error handling; User management and access control; Analytics and reporting tools for system-wide analysis.

Notification System: The system sends proactive notifications through multiple channels (email, in-app, SMS, mobile push) to inform stakeholders of: KPI achievements and improvements; Rewards earned and distributed; Approaching budget limits; Required approvals or actions; System alerts and anomalies.

All user interfaces follow modern design principles emphasizing clarity, accessibility, and responsiveness across devices. The system supports internationalization for organizations operating in multiple countries and languages.

### Scalability and Performance Optimization

As organizations grow and the volume of data increases, the system must maintain performance and responsiveness. The architecture includes several scalability features.

Distributed Processing: The system employs distributed computing architecture where processing is spread across multiple servers. Data collection, attribution calculations, and reward distributions can run in parallel, leveraging cloud computing infrastructure that automatically scales based on load.

Database Optimization: The data warehouse uses columnar storage formats optimized for analytical queries; implements partitioning strategies to divide large datasets by time periods or organizational units; maintains indexed structures for frequently accessed data; and archives historical data that is rarely accessed to separate storage tiers.

Caching Strategies: Frequently accessed data (current KPI values, recent attribution scores, user profiles) is cached in high-speed memory stores. Cache invalidation policies ensure data remains current while minimizing database queries. Calculated results (attribution scores, reward amounts) are cached with appropriate time-to-live values.

Asynchronous Processing: Long-running operations (complex attribution calculations, bulk data imports, report generation) execute asynchronously using job queues. Users receive notifications when operations complete rather than waiting synchronously.

Load Balancing: Multiple instances of the application run behind load balancers that distribute traffic based on server capacity and health. This provides both scalability and resilience against individual server failures.

### Audit Trail and Compliance Reporting

Organizations must comply with various legal and regulatory requirements regarding employee compensation, data privacy, and financial reporting. The system includes comprehensive audit trail and compliance capabilities.

Comprehensive Logging: Every system action is logged with: Timestamp (precise to the millisecond); User identifier (who took the action); Action type (what was done); Affected entities (which data was modified); Before and after values (what changed); IP address and device information; Result status (success or failure).

Immutable Audit Records: Audit logs are stored in append-only formats that prevent modification or deletion. Cryptographic hashing ensures any tampering would be immediately detectable. Logs are replicated to multiple geographic locations for redundancy.

Compliance Reports: The system generates various reports required for regulatory compliance: Payroll records suitable for tax reporting and accounting systems; Equal pay analysis showing compensation patterns across demographic groups to support non-discrimination compliance; Data processing records for privacy regulations (GDPR, CCPA, etc.); Financial audit trails showing reward calculations and distributions; Access logs demonstrating appropriate data handling and security controls.

Retention Policies: Configurable data retention policies ensure that records are kept for legally required durations (typically 7 years for financial records) while also supporting right-to-deletion requests under privacy regulations. Automated archival moves old data to long-term storage.

Export Capabilities: All audit and compliance data can be exported in standard formats (CSV, PDF, JSON) for submission to auditors, regulators, or legal counsel. Exports include cryptographic signatures to prove authenticity.

### Future Extensions and Modularity

The system architecture is designed with extensibility in mind, allowing organizations to adapt and enhance functionality as their needs evolve.

Plugin Architecture: The system supports plugin modules that can add new functionality without modifying core code. Potential plugins include: Custom attribution algorithms for industry-specific scenarios; Integration adapters for new data sources; Specialized reporting modules; Alternative reward distribution mechanisms; Machine learning models for predictive analysis.

API Extensibility: Comprehensive APIs allow external systems to: Query KPI data and attribution scores; Submit performance data from custom sources; Trigger reward calculations on demand; Retrieve reports and analytics; Configure system settings programmatically.

Machine Learning Integration: The system can incorporate machine learning models to: Predict future KPI trends based on historical patterns; Identify optimal attribution weights through reinforcement learning; Detect anomalies and fraud with greater sophistication; Provide personalized recommendations to employees; Optimize budget allocation dynamically.

Multi-tenancy Support: The architecture supports multi-tenant deployments where a single system instance serves multiple organizations with complete data isolation, allowing SaaS-style delivery models.

### Example Implementation

To illustrate the operation of the system, consider a mid-sized technology company with 500 employees that implements the TAIWA KPI Remuneration System.

The company identifies three primary KPIs to track: Customer Satisfaction Score (measured through surveys), Product Quality (measured through defect rates), and Revenue Growth (measured through sales data).

The system is configured to collect data from: The CRM system for customer satisfaction surveys; The bug tracking system for defect rates; The financial system for revenue data.

For Customer Satisfaction, the system uses a threshold-based attribution model where satisfaction scores must improve by at least 5 points to trigger rewards. For Product Quality, it uses direct correlation attribution since individual engineers'code contributions can be directly linked to defect rates. For Revenue Growth, it uses regression-based attribution since multiple factors influence sales outcomes.

During the first quarter, a customer support representative named Sarah implements a new problem resolution process. The system detects that customer satisfaction scores for her assigned accounts improve from 72 to 83, crossing the 5-point threshold. The attribution engine calculates her contribution, applies NI Balancing (checking whether other representatives'scores declined), and determines an attribution score.

Simultaneously, a software engineer named Michael refactors a critical code module, reducing defects by 15%. The direct correlation model attributes this improvement to his work. However, the system also notes that the refactoring took longer than scheduled, slightly impacting the team's velocity. The NI Balancing mechanism accounts for this trade-off.

At the end of the quarter, the reward calculation module processes all attribution scores, applies the configured budget constraints (the company allocated $100,000 for this quarter), and calculates individual rewards. Sarah receives $1,200 for her customer satisfaction improvements, and Michael receives $2,500 for his quality improvements.

The smart contract validates these calculations, checks for fraud indicators, and automatically submits the payments to payroll. Sarah and Michael receive notifications showing their rewards and explaining which specific improvements earned them. They can view their dashboards to see detailed attribution breakdowns and identify opportunities for future improvements.

Over time, the company observes that employees are more engaged, actively seeking ways to improve tracked KPIs, and the overall organizational performance improves measurably. The system's transparency and real-time feedback create a positive cycle of continuous improvement.

### Advantages Of The Invention

The present invention provides several significant advantages over traditional compensation systems:
1. Objective Attribution: By using data-driven analysis rather than subjective judgment, the system provides more accurate and fair attribution of organizational success to individual contributors.
2. Real-time Feedback: Employees receive immediate visibility into how their actions affect KPIs and what rewards they are earning, creating stronger motivational effects than delayed annual bonuses.
3. Transparency: The system's transparent calculation methods and audit trails build trust and reduce perceptions of unfairness or favoritism.
4. Scalability: The automated architecture can handle organizations of any size, from small teams to large enterprises with thousands of employees.
5. Flexibility: The modular design and configurable attribution models allow the system to adapt to different industries, organizational structures, and KPI types.
6. Fair Trade-off Handling: The NI Balancing mechanism ensures that improvements are rewarded based on net organizational value rather than narrow metrics that might be misleading.
7. Cost Efficiency: By automating reward calculations and distributions, the system reduces administrative overhead compared to manual performance review processes.

### ALTERNATIVE EMBODIMENTS

While the detailed description above presents a comprehensive implementation, those skilled in the art will recognize that various modifications and alternative embodiments are possible without departing from the scope of the invention.

For example, while the described system uses smart contracts on a blockchain for reward distribution, alternative implementations could use traditional database systems with appropriate audit controls. The key innovation of transparent, automated reward distribution can be achieved through various technical means.

Similarly, while the described attribution models (direct correlation, threshold-based, regression-based) cover common scenarios, organizations might develop custom attribution algorithms suited to their specific contexts. The invention encompasses any systematic, data-driven approach to attributing KPI improvements to individuals.

The system could be implemented entirely in cloud infrastructure, on-premises servers, or in hybrid configurations. The choice of deployment model does not affect the fundamental inventive concepts.

The invention could be extended beyond employee remuneration to other scenarios such as vendor performance rewards, partner incentive programs, or customer loyalty schemes, wherever there is a need to attribute outcomes to specific participants and distribute rewards accordingly.

### Conclusion

The present invention provides a comprehensive, automated system for employee remuneration based on objective measurement of individual contributions to organizational KPIs. Through sophisticated attribution algorithms, NI Balancing mechanisms, smart contract-based distributions, and comprehensive user interfaces, the system addresses long-standing limitations of traditional compensation approaches.

The invention enables organizations to more fairly and effectively reward employees for their actual contributions to organizational success, creating stronger alignment between individual actions and organizational outcomes. The resulting improvements in motivation, transparency, and fairness benefit both employers and employees. The scope of the present invention is defined by the appended claims.

1. A computer-implemented system for employee remuneration based on key performance indicators (KPIs), comprising:
a data collection module configured to gather organizational KPI data from multiple data sources;
an attribution engine configured to analyze the collected KPI data and determine attribution scores representing individual employee contributions to KPI improvements;
a negative improvement (NI) balancing module configured to adjust attribution scores based on detecting whether improvements in one area correspond to degradations in another area;
a reward calculation module configured to calculate financial rewards based on the adjusted attribution scores; and
a distribution system configured to distribute the calculated financial rewards to employees.

2. The system of claim 1, wherein the attribution engine implements multiple attribution models including at least: a direct correlation model for KPIs with measurable one-to-one relationships between employee actions and outcomes; a threshold-based model for KPIs that improve in discrete steps; and a regression-based model for KPIs influenced by multiple factors.

3. The system of claim 1, wherein the NI balancing module calculates a net improvement score using the formula: Net_Improvement=Positive_Improvements−(Weight_Factor×Negative_Improvements), where the Weight_Factor is configurable based on organizational priorities.

4. The system of claim 1, wherein the distribution system employs smart contract logic that automatically executes reward payments when predetermined conditions are satisfied, said smart contract logic encoding reward distribution rules including attribution thresholds, calculation formulas, distribution timing, validation rules, and audit trail requirements.

5. The system of claim 4, wherein the smart contract logic implements a two-gate validation process comprising: a first automated validation gate that verifies data integrity, calculation accuracy, policy compliance, and fraud detection; and a second optional management review gate that holds calculated rewards pending approval.

6. The system of claim 1, further comprising a baseline tracking module configured to: establish performance baselines for employees over a defined baseline period; calculate performance deltas by comparing current performance to established baselines; and periodically update baselines using an exponential weighted moving average to incorporate sustained improvements.

7. The system of claim 1, further comprising privacy safeguards including: encryption of data in transit and at rest; role-based access control with multi-factor authentication for sensitive operations; anonymization capabilities for system-wide analysis; and fraud detection mechanisms including anomaly detection algorithms and cross-validation of data sources.

8. The system of claim 1, further comprising a cross-organizational data exchange module implementing a federated architecture wherein: multiple organizations maintain separate system instances with local data storage; instances securely exchange data through standardized APIs using OAuth 2.0 authentication; and administrators configure which KPIs and data granularity levels are shared across organizational boundaries.

9. The system of claim 1, further comprising an economic modeling module configured to: manage budget constraints at global, departmental, and individual levels; calculate a scaling factor when earned rewards exceed available budget; compute return on investment (ROI) metrics comparing KPI improvement value to total rewards cost; and perform scenario modeling to simulate different reward structures.

10. The system of claim 1, further comprising user interface components including: an employee dashboard displaying current performance on tracked KPIs, attribution scores, earned rewards, and actionable insights; a manager dashboard showing aggregated team performance and pending approvals; an administrator console providing configuration tools and system monitoring; and a notification system sending alerts through multiple channels.

11. The system of claim 1, wherein the system architecture implements scalability features including: distributed processing across multiple servers; database optimization using columnar storage and partitioning; caching strategies for frequently accessed data; asynchronous processing using job queues; and load balancing across multiple application instances.

12. The system of claim 1, further comprising an audit trail module configured to: log every system action with timestamp, user identifier, action type, affected entities, before and after values, and result status; store audit logs in immutable append-only format with cryptographic hashing; generate compliance reports for payroll records, equal pay analysis, data processing records, and financial audit trails; and implement configurable data retention policies.

13. The system of claim 1, wherein the system supports extensibility through: a plugin architecture allowing addition of custom attribution algorithms, integration adapters, and specialized reporting modules;
comprehensive APIs enabling external systems to query data and trigger operations; machine learning integration for predictive analysis and optimization; and multi-tenancy support for serving multiple organizations.

14. The system of claim 2, wherein the direct correlation model calculates attribution score using the formula: Attribution_Score=(Individual_Impact/Total_Impact)×KPI_Improvement_Value; the threshold-based model triggers attribution when KPI_Current>Threshold_i and KPI_Previous≤Threshold_i; and the regression-based model estimates individual contribution coefficients using the form: KPI_Change=β₀+Σ(βᵢ×Individualᵢ_Actions)+ϵ.

15. The system of claim 1, wherein the attribution engine is further configured to recalculate baseline values dynamically over defined temporal windows comprising rolling-update intervals, periodic reassessment cycles, or event-triggered recalibration events, to ensure that KPI delta computations reflect sustained improvements rather than transient anomalies.

16. The system of claim 1, further comprising a compliance module configured to enforce jurisdiction-specific data-handling, privacy, consent, and reward-processing constraints during KPI attribution, negative improvement balancing, baseline updating, and smart-contract-based reward execution.

17. A computer-implemented method for employee remuneration based on key performance indicators (KPIs), comprising:
collecting organizational KPI data from multiple data sources;
analyzing the collected KPI data to determine attribution scores representing individual employee contributions to KPI improvements;
adjusting the attribution scores using negative improvement (NI) balancing that detects whether improvements in one area correspond to degradations in another area;
calculating financial rewards based on the adjusted attribution scores; and
distributing the calculated financial rewards to employees.

18. The method of claim 17, wherein analyzing the collected KPI data comprises applying multiple attribution models including: a direct correlation model for KPIs with measurable one-to-one relationships; a threshold-based model for KPIs that improve in discrete steps; and a regression-based model for KPIs influenced by multiple factors.

19. The method of claim 17, wherein adjusting the attribution scores comprises calculating a net improvement score using: Net_Improvement=Positive_Improvements−(Weight_Factor×Negative_Improvements), where the Weight_Factor is configurable based on organizational priorities.

20. The method of claim 17, wherein distributing the calculated financial rewards comprises: encoding reward distribution rules in smart contract logic; executing a first automated validation gate that verifies data integrity, calculation accuracy, policy compliance, and fraud detection; optionally executing a second management review gate; and automatically triggering payment when validation gates are passed.

21. The method of claim 17, further comprising: establishing performance baselines for employees over a defined baseline period; calculating performance deltas by comparing current performance to established baselines; and periodically updating baselines using an exponential weighted moving average.

22. The method of claim 17, further comprising implementing privacy safeguards by: encrypting data in transit and at rest; implementing role-based access control with multi-factor authentication; anonymizing data for system-wide analysis; and detecting fraud through anomaly detection algorithms and cross-validation of data sources.

23. The method of claim 17, further comprising exchanging data across organizational boundaries by: implementing federated architecture with separate system instances for each organization; securely exchanging data through standardized APIs using OAuth 2.0 authentication; and configuring which KPIs and data granularity levels are shared.

24. The method of claim 17, further comprising managing economic constraints by: enforcing budget constraints at multiple organizational levels; calculating a scaling factor when earned rewards exceed available budget according to: Actual_Reward=Earned_Reward×(Available_Budget/Total_Earned_Rewards); computing ROI metrics; and
performing scenario modeling.

25. The method of claim 17, further comprising providing user interfaces by: displaying to employees their current performance, attribution scores, earned rewards, and actionable insights; displaying to managers aggregated team performance and pending approvals; providing administrators with configuration tools and system monitoring; and sending notifications through multiple channels.

26. The method of claim 17, further comprising implementing scalability by: distributing processing across multiple servers; optimizing database queries using columnar storage and partitioning; caching frequently accessed data; processing long-running operations asynchronously; and load balancing across multiple application instances.

27. The method of claim 17, further comprising maintaining audit trails by: logging every system action with comprehensive metadata; storing logs in immutable append-only format with cryptographic hashing; generating compliance reports for regulatory requirements; and implementing configurable data retention policies.

28. The method of claim 17, further comprising supporting extensibility by: providing plugin architecture for custom functionality; exposing APIs for external system integration; incorporating machine learning models for predictive analysis; and supporting multi-tenant deployments.

29. The method of claim 18, wherein: the direct correlation model calculates Attribution_Score=(Individual_Impact/Total_Impact)×KPI_Improvement_Value; the threshold-based model triggers attribution when KPI_Current>Threshold_i and KPI_Previous≤Threshold_i; and the regression-based model calculates KPI_Change=β₀+Σ(βᵢ×Individualᵢ_Actions)+ϵ.

30. The method of claim 17, wherein the NI balancing detects zero-sum situations where one employee's gain corresponds to another employee's loss, and trade-off scenarios where improving one KPI degrades another KPI, and calculates net organizational benefit by weighting positive and negative improvements according to organizational priorities.
